(19) United States
(12) Patent Application Publication
(10) Pub. No.: US 2026/0065134 A1
(43) Pub. Date: Mar. 5, 2026

(54) PIXEL BASED WITH OBJECT BASED DECISION MAKING APPROACH FOR DRIVING

(71) Applicant: AUTOBRAINS TECHNOLOGIES LTD, Tel Aviv-Yafo (IL)

(72) Inventors: Igal RAICHELGAUZ, Tel-Aviv, Yafo (IL); Julius ENGELSOY, Tel-Aviv (IL)

(73) Assignee: AUTOBRAINS TECHNOLOGIES LTD, Tel Aviv-Yafo (IL)

(21) Appl. No.: 18/822,285

(22) Filed: Sep. 2, 2024

(51) Int. Cl. G06N 20/00; B60W 60/00; G06V 10/74

(52) U.S. Cl. CPC G06N 20/00; G06V 10/761; B60W 60/0013

(57) ABSTRACT

A method of a pixel based with object based decision making for driving, the method includes receiving, at a first machine learning process of an artificial intelligence agent, a sensed information unit; receiving, at a second machine learning process of the artificial intelligence agent, object descriptive information regarding an object captured in the sensed information unit; generating, by the first machine learning process, a pixel-based path planning output related to a suggested pixel-based path segment of a vehicle; generating, by the second machine learning process, an object-based path planning output related to a suggested object-based path segment of the vehicle; and generating, by at least in part processing the pixel-based path planning output in correspondence with the object-based path planning output, a driving related output with respect to the vehicle.

### BACKGROUND

Vehicles with autonomous driving capabilities and/or driver assistance capabilities are required to process in real time information regarding one or more road elements and to respond accordingly.

There is a growing need to improve the processing of information regarding road elements.

### SUMMARY

A method, system, and non-transitory computer readable medium as illustrated in the application.

### A BRIEF DESCRIPTION OF THE DRAWINGS

The embodiments of the disclosure will be understood and appreciated more fully from the following detailed description, taken in conjunction with the drawings in which:

FIG. 1 illustrates an example of a vehicle;

FIG. 2 illustrates an example of a method;

FIG. 3 illustrates an example of a method;

FIG. 4 illustrates an example of an artificial intelligence agent; and

FIG. 5 illustrates an example of a group of artificial intelligence agents and other units.

### DETAILED DESCRIPTION

The different figures illustrates examples of units and/or software and/or information items and/or steps and/or components. These examples are provided for brevity of explanation. At least one of the units and/or software and/or information items and/or steps and/or components is optional or mandatory.

According to an embodiment, there is provided a method for a compatible object-pixel based decision making with respect to a vehicle. The compatible object-pixel based decision making is made by different machine learning processes of the same artificial intelligence agent to provide an artificial intelligence agent driving related output that is responsive to both types of path planning (object-based path planning output and pixel-based path segment of the vehicle)—which provides a much more accurate artificial intelligence agent driving related output.

According to an embodiment, the artificial intelligence agent driving related output may be based on only one of the path planning outputs—for example when finding that one of the artificial intelligence agent driving related outputs is not associated with at least a defined threshold of confidence level.

According to an embodiment—there is provided a group of artificial intelligence agents and following a selection process, one or more artificial intelligence agents of the group are selected to concurrently provide one or more artificial intelligence agent driving related outputs to be processed to provide a group artificial intelligence agent driving related output.

The fusion of the distinct types of path planning outputs also increases the accuracy of the group artificial intelligence agent driving related output—especially when a single artificial intelligence agent is selected.

The accuracy of the method also increases when the group artificial intelligence agent driving related output is based on at least one of the confidence level associated with the one or more artificial intelligence agent driving related outputs and/or based on whether one or more types of path panning contributed to the artificial intelligence agent driving related outputs.

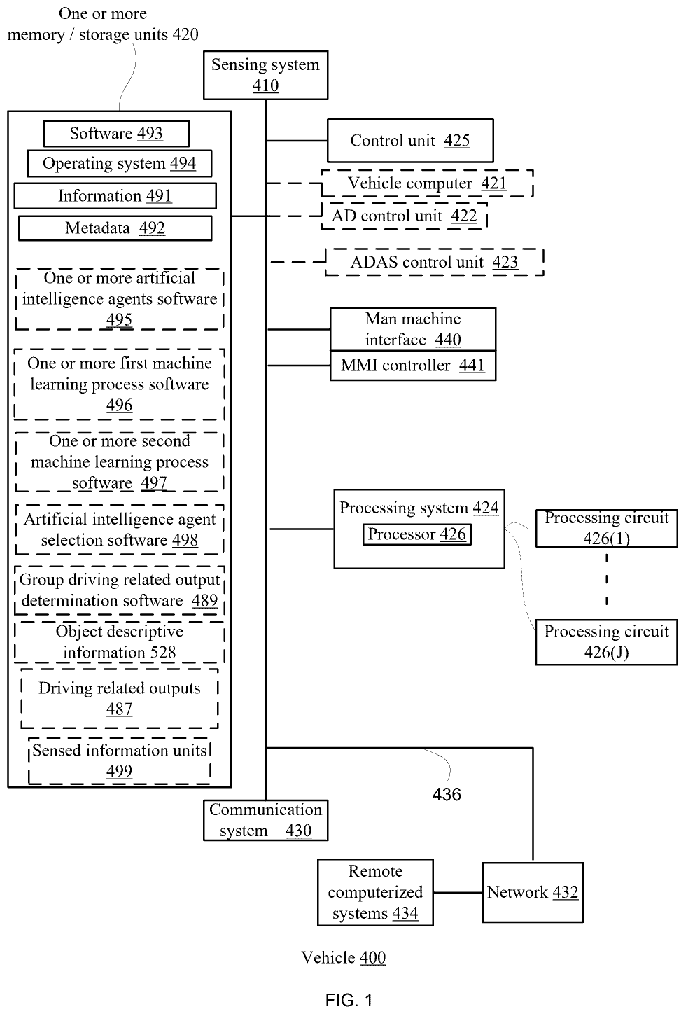

FIG. 1 illustrates an example of a vehicle 400.

Vehicle 400 includes a man machine interface 440 having or being in communication with man machine interface (MMI) controller 441, a communication system 430, one or more memory and/or storage units 420, a processing system 424 including processor 426. The communication system 430, the one or more memory and/or storage units 420, and the processing system 424 may belong to a computerized system of vehicle 400. The computerized system may be a server, a laptop, a desktop, or any other computer and may include or be in communication with a sensing unit and/or a controller.

According to an embodiment, vehicle 400 is in communication with network 432 and one or more other remote computerized systems 434 that are in communication with network 432. An example of a remote computerized system is a server or one or more computers having access to a storage system that stores items related to one or more portions of one or more groups of neural networks-at least some of which are not currently stored in the vehicle.

According to an embodiment, the communication system 430 is configured to enable communication between the one or more memory and/or storage units 420 and/or any one of the additional units and/or the network 432 (that is in communication with the remote computerized systems). Communication system 430 is also configured to enable communication with other elements such as sensing system 410, man machine interface 440, control unit 425, vehicle computer 421, autonomous driving control unit 422 (denoted AD control unit), advanced driver assistance system (ADAS) control unit 423 (denoted ADAS control unit), and the like.

The memory and/or storage units 420 was shown as storing software. Any reference to software should be applied mutatis mutandis to code and/or firmware and/or instructions and/or commands, and the like.

Processor 426 includes a plurality of processing units 426(1)-426(J), J is an integer that exceeds one. Any reference to one unit or item should be applied mutatis mutandis to multiple units or items. For example-any reference to processor should be applied mutatis mutandis to multiple processors, any reference to communication system 430 should be applied mutatis mutandis to multiple communication systems.

According to an embodiment, the one or more memory and/or storage units 420 includes one or more memory unit, each memory unit may include one or more memory banks.

According to an embodiment, the one or more memory and/or storage units 420 includes a volatile memory and/or a non-volatile memory. The one or more memory and/or storage units 420 may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory and/or storage units.

According to an embodiment, the at least one memory unit stores at least one database—such as any database known in the art—such as DB2@, Microsoft® Access, Microsoft® SQL Server, Oracle®, mySQL, PostgreSQL, and the like.

The memory and/or storage units 420 are configured to store firmware and/or software, one or more operating systems, data and metadata required to the execution of any of the methods mentioned in this application.

The memory and/or storage units 420 was shown as storing software. Any reference to software should be applied mutatis mutandis to code and/or firmware and/or instructions and/or commands, and the like.

Various units and/or components are in communication with each other using any communication elements and/or protocols. An example of a communication system is denoted 430. Other communication elements may be provided.

The communication system 430 may be in communication with bus 436. The bus represents one or more of several types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

Network 432 that is located outside the vehicle and is used for communication between the vehicle and at least one remote computing system. By way of example, a remote computing system can be a personal computer, a laptop computer, portable computer, a server, a router, a network computer, a peer device, or other common network node, and so on. Logical connections between the processor and either one of remote computing systems can be made via a local area network (LAN) and a general wide area network (WAN). Such network connections can be through a network adapter (may belong to communication system 430) which can be implemented in both wired and wireless environments. Such networking environments are conventional and commonplace in offices, enterprise-wide computer networks, intranets, and a larger network such as the internet.

It should be noted that at least a part of the content illustrated as being stored in one or more memory/storage units 420 may be stored outside the vehicle. It should also be noted that the processor may evaluate signatures generated by a plurality of detectors.

Examples of generating signatures and/or cropping images are provided in U.S. patent application Ser. No. 18/527,701 which is incorporated herein by reference.

According to an embodiment, the memory and/or storage units 420 stores at least one of: operating system 494, information 491 such as sensed information units 499, object descriptive information 528, metadata 492 such as driving related outputs 487, and software 493 such as one or more artificial intelligence agents software 495 for implementing one or more AI agents, one or more first machine learning process software 496 for generating one or more pixel-based path planning outputs, one or more second machine learning process software 497 for generating one or more object-based path planning outputs, artificial intelligence agent selection software 498 for selecting one or more artificial intelligence agents, group driving related output determination software 489 for determining a group driving related output. The software are used for executing at least one of method 200 and/or method 300.

The control unit 425 may cooperate with ADAS control unit 423 and/or with AD control unit 422 and/or may control or communicate with other vehicle components—including vehicle computer.

The ADAS control unit 423 is configured to control ADAS operations.

The AD control unit 422 is configured to control autonomous driving of the autonomous vehicle.

The vehicle computer 421 is configured to control the operation of the vehicle—especially controlling the engine, the transmission, and any other vehicle system or component.

The vehicle computer 421 may be in communication with an engine control module, a transmission control module, a powertrain control module, and the like.

The sensing system 410 may include optics, a sensing element group, a readout circuit, and an image signal processor. Optics are followed by a sensing element group such as line of sensing elements or an array of sensing elements that form the sensing element group. The sensing element group is followed by a readout circuit that reads detection signals generated by the sensing element group. An image signal processor is configured to perform an initial processing of the detection signals—for example by improving the quality of the detection information, performing noise reduction, and the like. The sensing system 410 is configured to output one or more sensed information units (SIUs).

Control unit 425 is configured to control the operation of the sensing system 410, and/or the one or more memory and/or storage units 420 and/or the one or more additional units (except the controller).

By way of example and not meant to be limiting, computer readable media can comprise “computer storage media” and “communications media.” “Computer storage media” comprise volatile and non-volatile, removable, and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

Any content may be stored in any part or any type of memory and/or storage units.

According to an embodiment, at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 430. Other communication elements may be provided.

According to an embodiment, processing system 424 alone or in combination of any other unit illustrated above, is configured to perform, while executing software, at least of method 200 or method 300.

According to an embodiment, processing system 424 alone or in combination of any other unit illustrated above, is configured to execute at least one step of at least one method of methods 200 and 300.

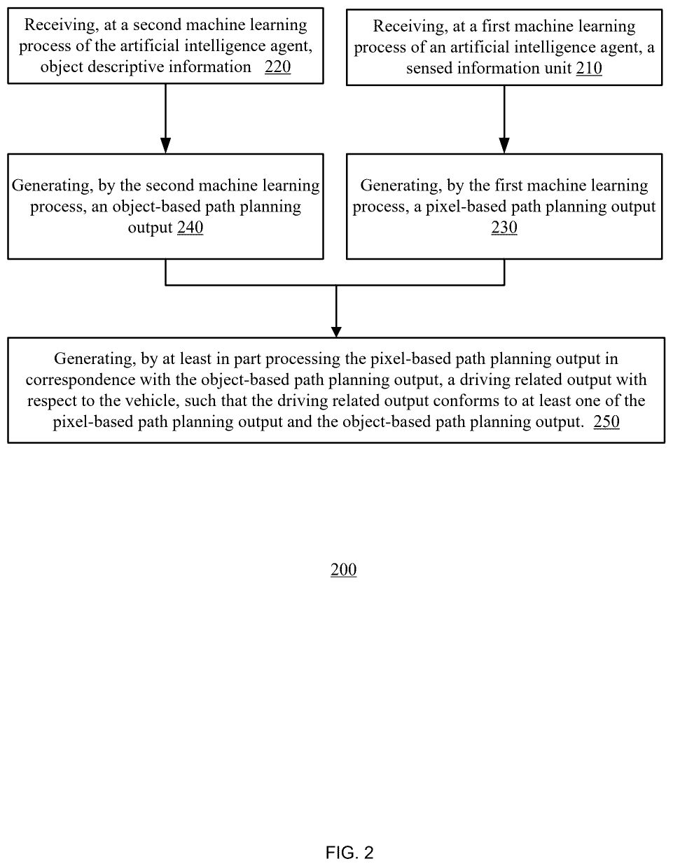

FIG. 2 illustrates an example of method 200 of compatible object-pixel based decision making with respect to a vehicle.

According to an embodiment, method 200 includes steps 210 and 220.

According to an embodiment, step 210 includes receiving, at a first machine learning process of an artificial intelligence agent, a sensed information unit.

According to an embodiment, step 220 includes receiving, at a second machine learning process of the artificial intelligence agent, object descriptive information regarding an object captured in the sensed information unit. The object descriptive information is less detailed than the sensed information unit. It may be seen as a higher-level more compact representation.

According to an embodiment, the object descriptive information includes object location information relating to the captured object in an environment of the vehicle, and kinematic information—for example velocity of the captured object and/or relative velocity between the captured object and the vehicle.

According to an embodiment, step 210 is followed by step 230 of generating, by the first machine learning process, a pixel-based path planning output related to a suggested pixel-based path segment of the vehicle.

According to an embodiment, step 220 is followed by step 240 of generating, by the second machine learning process, an object-based path planning output related to a suggested object-based path segment of the vehicle.

According to an embodiment, steps 230 and 240 are followed by step 250 of generating, by at least in part processing the pixel-based path planning output in correspondence with the object-based path planning output, a driving related output with respect to the vehicle, such that the driving related output conforms to at least one of the pixel-based path planning output and the object-based path planning output. The first machine learning process and the second machine learning running concurrently for decision making driving of the vehicle.

According to an embodiment, the driving related output provides an artificial intelligence agent path segment of the vehicle. According to an embodiment, the driving related output suggests to a human driver or to a control unit (such as an ADAS control unit and/or an AD control unit) to follow the path segment or instructs the control unit to follow the path segment and/or triggers a control unit (ADAS control unit and/or an AD control unit) to determine a vehicle path segment.

According to an embodiment, there may be provided a group of artificial intelligent agents, and one or more artificial intelligent agents of the group are used concurrently to generate one or more paths segments (one or more artificial intelligent agents of the group are used concurrently to generate driving related decisions)—and the one or paths segments are further processed to provide a further path segment to be provided as an output.

Referring back to method 200—according to an embodiment, each path segment (the suggested object-based path segment, the suggested pixel-based path segment, and a path segment generated during step 250) is related to a path segment to be followed by the vehicle within a time period following the execution of step 250. According to an embodiment the time period ranges between a fraction of a second to few seconds (few—for example between 2 and 10), or between 10 and few tens of seconds, or between a few tens of seconds to one or more minutes, and the like.

According to an embodiment, the generating of the driving related output is based in part on a safety parameter. The safety parameter may be determined in various manners—for example based on statistics (for example percent of accidents) associated with each path segment.

According to an embodiment, the generating of the driving related output is based at least in part on a comfort of a passenger of the vehicle.

According to an embodiment, step 230 includes determining, by the first machine learning process, a suggested pixel-based path segment confidence level.

According to an embodiment, step 240 includes determining, by the second machine learning process, a suggested object-based path segment confidence level.

According to an embodiment, step 250 is responsive to the suggested pixel-based path segment confidence level and to the suggested object-based path segment confidence level.

According to an embodiment—step 250 includes at least one of:
A. Providing weights to the suggested object-based path segment and to the suggested object-based path segment.
B. Generating the driving related output based on the weights. Any function that considers the weights may be used—for example a weighted sum, and the like.
C. Determining a difference (weighted or unweighted) difference between the suggested object-based path segment and the suggested object-based path segment.
D. Selecting one of the suggested object-based path segment and the suggested object-based path segment.
E. Selecting one of the suggested object-based path segment and the suggested object-based path segment—when a difference (weighted or unweighted) difference between the suggested object-based path segment and the suggested object-based path segment exceeds a difference threshold.
F. Fusing the suggested object-based path segment and the suggested object-based path segment—when the difference (weighted or unweighted) difference between the suggested object-based path segment and the suggested object-based path segment does not exceed a difference threshold.
G. Generating the driving related output by averaging the suggested object-based path segment and the suggested object-based path segment.
H. Selecting, out of the suggested object-based path segment and the suggested object-based path segment, the path segment that is safer. The risk may be determined in one or more manners. For example—the risk is determined based on the distance between the vehicle and one or more other vehicles and/or one or more other pedestrians. For another example-the risk is determined based on potential damage that may occur to the vehicle if following the path segment.
I. Selecting, out of the suggested object-based path segment and the suggested object-based path segment, the path segment that has a lower acceleration value.
J. Selecting, out of the suggested object-based path segment and the suggested object-based path segment, the path segment that has a lower direction change value.
K. Selecting, out of the suggested object-based path segment and the suggested object-based path segment, the path segment that has a lower speed value.
L. Selecting out of the suggested object-based path segment and the suggested object-based path segment, the path segment that has exhibits a lower power consumption value.
M. Selecting, out of the suggested object-based path segment and the suggested object-based path segment, the path segment that exhibits a higher comfort level.
N. Selecting, out of the suggested object-based path segment and the suggested object-based path segment, the path segment that has a higher acceleration value.
O. Selecting, out of the suggested object-based path segment and the suggested object-based path segment, the path segment that has a higher direction change value.
P. Selecting, out of the suggested object-based path segment and the suggested object-based path segment, the path segment that has a higher speed value.
Q. Selecting, out of the suggested object-based path segment and the suggested object-based path segment, the path segment that has exhibits a higher power consumption value.
R. Selecting, out of the suggested object-based path segment and the suggested object-based path segment, the path segment that exhibits a lower comfort level.
S. Selecting, out of the suggested object-based path segment and the suggested object-based path segment, based on a current status of the vehicle—for example if the fuel level (or battery level) is below a first threshold—selecting the more power efficient path segment. If, for example the fuel level (or battery level) is below a first threshold—the ignore of provide a lower weights to the power consumption.
T. Selecting, out of the suggested object-based path segment and the suggested object-based path segment, based on a profile of a driver of the vehicle.
U. Identifying that the pixel-based path planning output contradict the object-based path planning output and responding to the contradiction. Contradiction may include suggesting to drive at different direction (at least difference of more than 10, 15, 20, 25, 30, 35, 40, 45, 50, 70, 80, 90 degrees—and/or suggesting to drive at different road paths) and/or suggesting different accelerations (for example—acceleration versus deceleration, no acceleration versus significant acceleration—for example of more than 0.3 G) and/or suggesting different velocities (for example speed difference of at least 10, 20, 30, 40 and more miles per hour).
V. Identifying a suggested paths segment violates a traffic rule and/or traffic regulation.
W. Ignoring a suggested path segment that violates a traffic rule and/or traffic regulation.
X. Modifying at least one suggested path segment that violates a traffic rule and/or traffic regulation.
Y. According to an embodiment, the generating of the driving related output is based at least in part on a timing constraints—for example generating a path segment that once followed will contribute to comply with a timing constraints—for example a driver defined timing constraint, a traffic regulation imposed traffic constraint, a curfew start or end timing constraint, and the like.
Z. Determining an artificial intelligence agent path segment confidence level based on at least one of the suggested pixel-based path segment confidence level and to the suggested object-based path segment confidence level.
AA. Generating an indication of whether the artificial intelligence agent path segment is determined based on (a) both the suggested pixel-based path segment confidence level and the suggested object-based path segment confidence level—or (b) on only one of the suggested object-based paths segments. According to an embodiment more weights is assigned to the artificial intelligence agent path segment in case (a)—in relation to case (b).

According to an embodiment, there may be provided a group of artificial intelligent agents and one or more artificial intelligent agents of the group are used concurrently to generate one or more paths segments (one or more artificial intelligent agents of the group are used concurrently to generate driving related decisions)—and the one or paths segments are further processed to provide a further path segment to be provided as group driving related output.

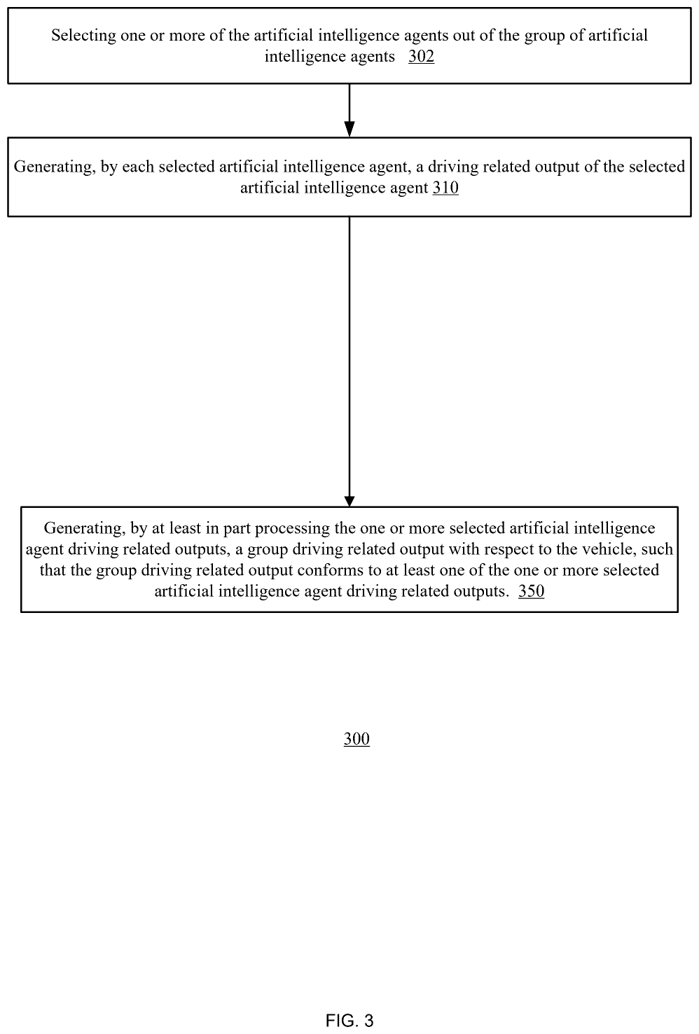

FIG. 3 illustrates an example of method 300 that is executed in the presence of a group of artificial neural network agents.

According to an embodiment, method 300 includes step 302 of selecting one or more of the artificial intelligence agents out of the group of artificial intelligence agents to provide one or more selected artificial intelligence agents.

According to an embodiment, step 302 includes selecting the one or more selected artificial intelligence agent based on the scenario.

According to an embodiment, step 302 includes determining a scenario being faced by the vehicle, based on the sensed information unit, and/or receiving a situation indicator.

According to an embodiment, 302 is followed by step 310 of generating, by each selected artificial intelligence agent, a driving related output of the selected artificial intelligence agent—to provide one or more selected artificial intelligence agent driving related outputs.

According to an embodiment, a driving related output of the selected artificial intelligence agent is indicative of a selected artificial intelligence agent path segment.

According to an embodiment, each selected artificial intelligence agent executes step 310 by performing steps 210, 220, 230, 240 and 250 of method 200.

According to an embodiment, step 310 is followed by step 350 of generating, by at least in part processing the one or more selected artificial intelligence agent driving related outputs, a group driving related output with respect to the vehicle, such that the group driving related output conforms to at least one of the one or more selected artificial intelligence agent driving related outputs. According to an embodiment, the one or more selected artificial intelligence agents are running concurrently for decision making driving of the vehicle.

According to an embodiment, the group driving related output is indicative of a group path-segment.

According to an embodiment, the generating of the driving related output is based in part on a safety parameter. The safety parameter may be determined in various manners—for example based on statistics (for example percent of accidents) associated with each path segment.

According to an embodiment, the generating of the driving related output is based at least in part on a comfort of a passenger of the vehicle.

According to an embodiment, step 350 is responsive to one or more artificial intelligence agent path segment confident levels.

Any criterion mentioned in relation to step 250 is applicable, mutatis mutandis to the execution of step 350.

According to an embodiment and assuming that the one or more selected artificial intelligence agent driving related outputs are multiple selected artificial intelligence agent driving related outputs,—step 350 includes at least one of:
A. Providing weights to each of the multiple selected artificial intelligence agent driving related outputs.
B. Generating the driving related output based on the weights. Any function that considers the weights may be used—for example a weighted sum, and the like.
C. Determining a difference (weighted or unweighted) difference between the multiple selected artificial intelligence agent driving related outputs.
D. Selecting one of the multiple selected artificial intelligence agent driving related outputs.
E. Selecting one of the multiple selected artificial intelligence agent driving related outputs—when the difference (weighted or unweighted) difference between multiple selected artificial intelligence agent driving related outputs exceeds a difference threshold.
F. Fusing the multiple selected artificial intelligence agent driving related outputs—when the difference (weighted or unweighted) difference between multiple selected artificial intelligence agent driving related outputs does not exceed a difference threshold.
G. Generating the driving related output by averaging the multiple selected artificial intelligence agent driving related outputs.
H. Selecting out of the multiple selected artificial intelligence agent driving related outputs, the selected artificial intelligence agent driving related output that is safer. The risk may be determined in one or more manners. For example—the risk is determined based on the distance between the vehicle and one or more other vehicles and/or one or more other pedestrians. For another example—the risk is determined based on potential damage that may occur to the vehicle if following the path segment.
I. Selecting out of the multiple selected artificial intelligence agent driving related outputs, the selected artificial intelligence agent driving related output that has a lower acceleration value.
J. Selecting out of the multiple selected artificial intelligence agent driving related outputs, the selected artificial intelligence agent driving related output that has a lower direction change value.
K. Selecting out of the multiple selected artificial intelligence agent driving related outputs, the selected artificial intelligence agent driving related output that has a lower speed value.
L. Selecting out of the multiple selected artificial intelligence agent driving related outputs, the selected artificial intelligence agent driving related output that has exhibits a lower power consumption value.
M. Selecting out of the multiple selected artificial intelligence agent driving related outputs, the selected artificial intelligence agent driving related output that exhibits a higher comfort level.
N. Selecting, out of the multiple selected artificial intelligence agent driving related outputs, the path segment, the path segment that has a higher acceleration value.
O. Selecting out of the multiple selected artificial intelligence agent driving related outputs, the path segment, the path segment that has a higher direction change value.
P. Selecting, out of the suggested object-based path segment and the suggested object-based path segment, the path segment that has a higher speed value.
Q. Selecting, out of the suggested object-based path segment and the suggested object-based path segment, the path segment that has exhibits a higher power consumption value.
R. Selecting out of the multiple selected artificial intelligence agent driving related outputs, the path segment that exhibits a lower comfort level.
S. Selecting, out of the multiple selected artificial intelligence agent driving related outputs, based on a current status of the vehicle—for example if the fuel level (or battery level) is below a first threshold—selecting the more power efficient path segment. If, for example the fuel level (or battery level) is below a first threshold—the ignore of provide a lower weights to the power consumption.
T. Selecting out of the multiple selected artificial intelligence agent driving related outputs, based on a profile of a driver of the vehicle.
U. Identifying that the multiple selected artificial intelligence agent driving related outputs contradict each other and responding to the contradiction. Contradiction may include suggesting to drive at different direction (at least difference of more than 10, 15, 20, 25, 30, 35, 40, 45, 50, 70, 80, 90 degrees—and/or suggesting to drive at different road paths) and/or suggesting different accelerations (for example—acceleration versus deceleration, no acceleration versus significant acceleration—for example of more than 0.3 G) and/or suggesting different velocities (for example speed difference of at least 10, 20, 30, 40 and more miles per hour).
V. Identifying a selected artificial intelligence agent driving related output that violates a traffic rule and/or traffic regulation.
W. Ignoring a selected artificial intelligence agent driving related output that violates a traffic rule and/or traffic regulation.
X. Modifying at least one selected artificial intelligence agent driving related output that violates a traffic rule and/or traffic regulation.
Y. According to an embodiment, the generating of the group driving related output is based at least in part on a timing constraints—for example generating a path segment that once followed will contribute to comply with a timing constraints—for example a driver defined timing constraint, a traffic regulation imposed traffic constraint, a curfew start or end timing constraint, and the like.
Z. Determining the group driving related output based on intelligence agent path segment confidence levels of the multiple selected artificial intelligence agent driving related outputs.
AA. Determining the group driving related output based on whether one or more of the multiple selected artificial intelligence agent driving related outputs are generated based on (a) both the suggested pixel-based path segment confidence level and the suggested object-based path segment confidence level—or (b) on only one of the suggested object-based paths segments. According to an embodiment more weights is assigned to a selected artificial intelligence agent driving related output in case (a)—in relation to case (b).

Assuming the one or more selected artificial intelligence agents also include another selected artificial intelligence agent. In this case step 310 may also include: selecting, concurrently with the selecting of the artificial intelligence agent, another artificial intelligence agent; receiving, at another first machine learning process of the other artificial intelligence agent, the sensed information unit; receiving, at another second machine learning process of the other artificial intelligence agent, the object descriptive information; generating, by the other first machine learning process, another pixel-based path planning output related to another suggested pixel-based path segment of the vehicle; generating, by the other second machine learning process, another object-based path planning output related to another suggested object-based path segment of the vehicle; and generating, by at least in part processing the other pixel-based path planning output in correspondence with the other object-based path planning output, another driving related output with respect to the vehicle.

According to an embodiment, step 350 includes generating, based on the driving related output and the other driving related output, a further driving related output.

According to an embodiment, the further driving related output is the group driving related output.

According to an embodiment, the group driving related output of method 300 and/or the driving related output of method 200 includes at least one of:
A. An instruction executable by a man machine interface controller, to provide a recommendation to a driver regarding a navigation of the vehicle.
B. A request aimed to the man machine interface controller, to provide a recommendation to a driver regarding a navigation of the vehicle.
C. An instruction executable by an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
D. A request aimed to an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
E. An instruction executable by a driver assistance control unit (such as but not limited to an ADAS control unit) of the vehicle to perform a driver assisting operation—such as suggesting to the driver a suggested path of progress, a suggested speed and/or acceleration and/or direction of the vehicle or performing an autonomous braking operation or performing a lane maintenance operation of temporarily, during a short period, takeover the control of the vehicle, and the like.
F. A request aimed to a driver assistance control unit (such as but not limited to an ADAS control unit) of the vehicle to perform a driver assisting operation—such as suggesting to the driver a suggested path of progress, a suggested speed and/or acceleration and/or direction of the vehicle or performing an autonomous braking operation or performing a lane maintenance operation of temporarily, during a short period, takeover the control of the vehicle, and the like.
G. An instruction executable by a computer vehicle related to a manner of operation of any component of the vehicle such as brakes, engine, and the like.
H. A request sent to a computer vehicle related to a manner of operation of any component of the vehicle such as brakes, engine, and the like.
I. Information about the environment of the vehicle.
J. A prediction of a future path of the vehicle.
K. A prediction of a behavior of one or more road element.
L. An emergency alert.
M. A collision alert.

According to an embodiment, the method includes outputting and/or transmitting an/or storing and/or instructing to respond to and/or triggering a response to and/or controlling a response to and/or performing a respond to any of the driving related output listed above and/or below.

According to an embodiment, the method includes generating and/or requesting and/or determining and/or instructing and/or triggering and/or controlling and/or transmitting and/or outputting and/or preforming at least one of a warning, an alert signal, a driving alert, an estimated future driving of the vehicle, an estimated future behavior (e.g. movement) of any road element, an autonomous driving operation, an driving assistance output, a prediction output with respect to the behavior (e.g. movement, etc) of the element in the environment—and/or in the environment with re to the vehicle, an operation and/or response in compliant with one or more levels of autonomous driving—such as L2, L2+, L2++, L3 or L4 autonomous driving.

The providing may include storing at a location accessible to another unit controller, transmitting the instructions to the other unit, sending an indication about the generation of the instructions to the other unit man machine interface controller.

According to an embodiment, the method may include outputting and/or transmitting an/or storing and/or instructing to respond to and/or triggering a response to and/or controlling a response to and/or performing a respond to any of the driving related output listed above and/or below.

Any combination of any step of any method illustrated in the application is provided.

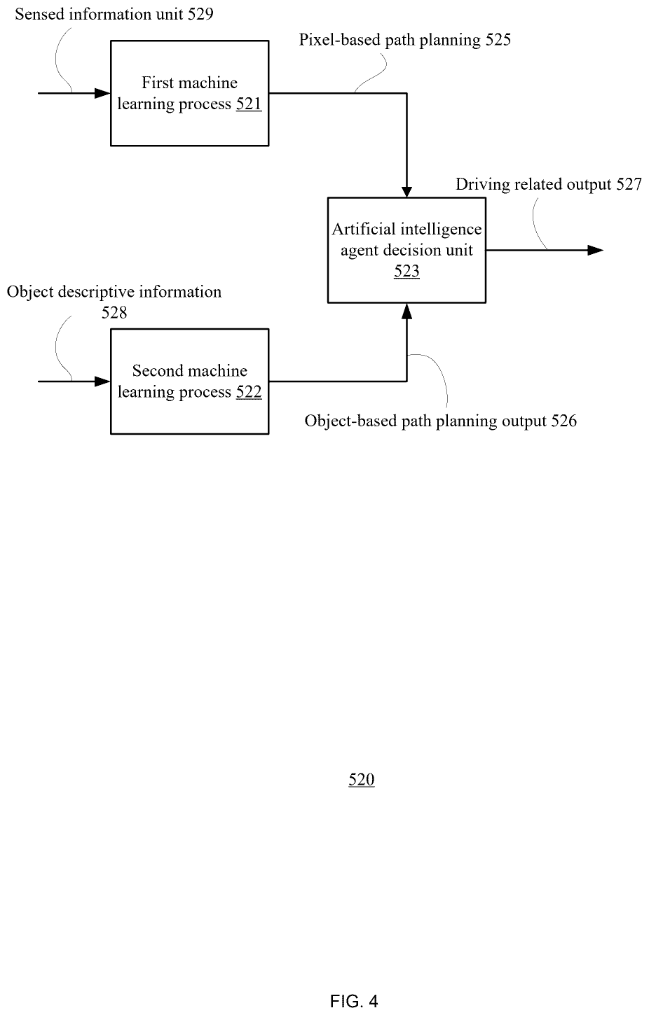

FIG. 4 illustrate an example of an artificial intelligence agent 520.

According to an embodiment, the artificial intelligence agent 520 includes:
A. A first machine learning process 521 is configured to receive a sensed information unit 529 and generate the pixel-based path planning 525. According to an embodiment the first machine learning process is implemented by one or more transformers, by a transfuser (when fed with two types of sensed information units)—see TransFuser: Limitation with Transformer-Based Sensor Fusion for Autonomous driving, K. Chitta, el at., arXiv:2205.15997. Using multiple transformers though is that the output is embeddings representing a birds eye view of the ego surroundings and it absorbs features at different depth in the backbone (high and low level abstraction).
B. A second machine learning process 522 configured to receive object descriptive information 528 that is less detailed than the sensed information unit, and to generate an object-based path planning output 526. The object descriptive information may be text and/or numbers—whereas the object is expected span along multiple pixels and the object descriptive information may be much smaller—for example less than 0.1, 0.5, 1, 2, 5, 10 percent—than the size of the sensed information unit.
C. An artificial intelligence agent decision unit 523 configured to generate, by at least in part processing the pixel-based path planning output in correspondence with the object-based path planning output, a driving related output 527 (also referred to as artificial intelligence agent driving related output) with respect to the vehicle, such that the driving related output conforms to at least one of the pixel-based path planning output and the object-based path planning output.

According to an embodiment the second machine learning process 522 receives object descriptive information 528 that includes (per object captured by the sensed information unit) object coordinates—such as bounding box coordinates (X, Y) and/or size (for example length L1 and width W1) of a bounding box that initially defines the object in the sensed information unit, velocity of the object (for example velocity VI, U1 along two axes).

According to an embodiment, the second machine learning process 522 also receives additional information such as ego information such as vehicle speed (ego V), lane coefficients (for example—three or more coefficients C0, C1 and C2 of a second degree polynomial that defines the shape of each lane border within the sensed information unit.

According to an embodiment, kinematic variables (such as velocity of each object, and ego speed) would correspond to words in large language models, and the positional encoding may just contain information about the position of the words in the prompt. The learning of semantics is done by an encoder of the second machine learning process 522.

According to an embodiment, an ego vehicle token corresponds to either a next word token or a class token depending on the task. That corresponding output token is fed to a classifier in the case of LLMs (to predict the next word) and in our case to a head that predicts the vehicle trajectory. Class labels are also added to each object and to each lane.

According to an embodiment, the second machine learning process 522 and an object descriptive information unit that precedes the second machine learning process 522 converts various information to tokens and the second machine learning process 522 provides a token-based decision.

According to an embodiment, the second machine learning process 522 is implemented by a transformer.

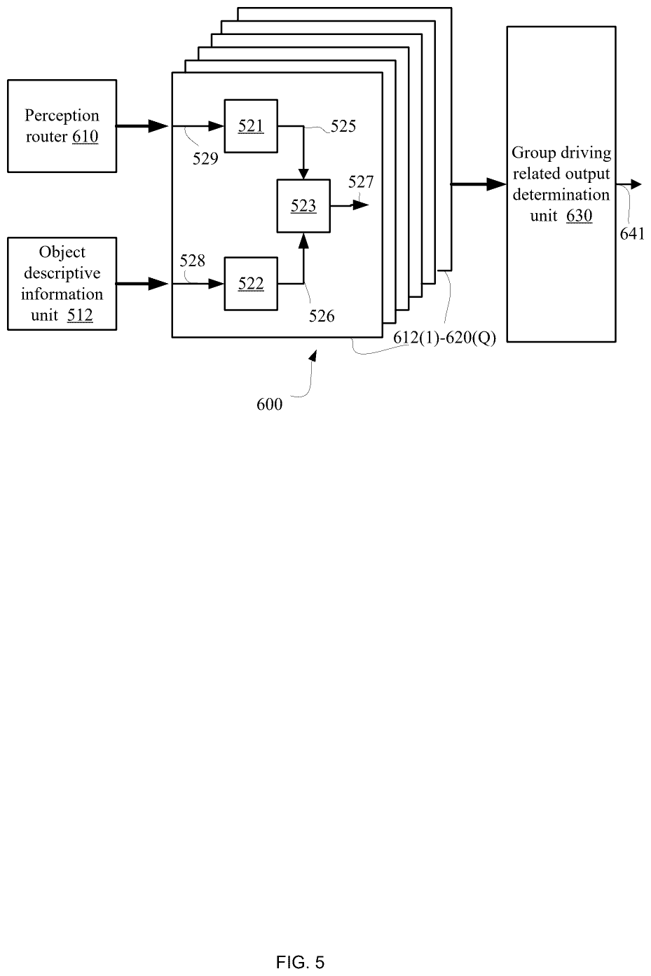

FIG. 5 illustrate an example of a group 600 of artificial intelligence agents 620(1)-620(Q), a perception router 610, object descriptive information unit 512, and a group driving related output determination unit 630 for generating group driving related output 641.

According to an embodiment, any artificial intelligence agent is a narrow artificial intelligence agent in the sense that is used for only a fraction of the time and/or selected only for a fraction of times and/or is trained to generate driving related decisions only for a fraction of a situations faced by the vehicle.

According to an embodiment fraction may range between 10⁻⁶ to 0.1, between 0.001 to 0.01, and the like. When not used the artificial intelligence agent may be idle or shut down—to reduce resource consumption.

According to an embodiment, an artificial intelligence agent refers to an autonomous entity which acts, directing its activity towards achieving goals (i.e. it is an agent), upon an environment using observation through sensors and consequent actuators (i.e. it is intelligent). Intelligent agents may also learn or use knowledge to achieve their goals. They may be very simple or very complex. (www.wikipedia.org).

According to an embodiment the group of artificial intelligence agents is an ensemble of artificial intelligence agents as illustrated in U.S. patent application Ser. No. 17/817,935 which is incorporated herein by reference.

According to an embodiment, the number of artificial intelligence agents of the group may for example—exceed 100, exceed 500, exceed 1000, exceed 10,000, exceed 100,000 and the like.

According to an embodiment, the number of one or more artificial intelligence agents that are concurrently activated (at any given point of time) does not exceed, 3, 5, 8, 10, 15, 20, and the like.

According to an embodiment, perception unit 610 is preceded by the one or more sensors and/or by one or more interfaces form receiving one or more sensed information units. The perception unit may be configured to receive a sensed information unit from an I/O interface and/or from a sensor. The perception unit may be followed by multiple narrow AI agents—also referred to an ensemble of narrow AI agents.

A narrow AI agent may be trained to respond to only some factors or elements or parameters or variables that form a scenario.

The narrow AI agents may be of the same complexity and/or of same parameters (depth, energy consumption, technology implementation)—but at least some of the narrow AI agents may differ from each other by at least one of complexity and/or parameters.

The narrow AI agents may be trained in a supervised manner and/or non-supervised manner.

One or more narrow AI agents may be a neural network or may differ from a neural network.

The ensemble may include one or more sensors and any other entity for generating a sensed information unit and/or may receive (by an interface) one or more sensed information units from the one or more sensors.

The perception unit may process the one or more sensed information units and determine which narrow AI agents are relevant to the processing of the one or more sensed information units.

There may be provided an autonomous vehicle system that may use the perception unit to classify the observed scene into multiple coarse grained categories. The system may include an ensemble of narrow AI agents (EoN).

The perception unit may receive and/or generate anchors that once detected (by the perception unit), may affect the selection of which narrow AI agents to select. The number of anchors may be very big (for example—above 100, 500, 1000, 10,000, 20,000, 50,000, 100,000 anchors and even more). For a given scenario (may be represented by one or more sensed information units such as but not limited to one or more images), the perception unit may detect one or more anchors. The detected anchors may provide sufficient contextual cues to allow the perception unit to determine which are the relevant narrow AI agents.

The contextual cue may be a high-level sensed information unit context. It is high level in the sense that the determining of the contextual cue is less complex and/or requires less computational resources than performing object detection of a small object in a sensed information unit. A small object may be of a minimal size to be detected, may be, for example of a size of a few tens of pixels, may be of a size that is smaller than 0.1, 0.5, 1, 2, 3 percent of the sensed information unit, and the like. The determining of the contextual cue may not, for example, include determining the exact locations of each object in the image—including the locations of objects that appear as few tens of pixels in an image. By searching for high-level sensed information unit context, the power consumption of the perception unit may be much lower (for example even up to two orders of magnitude lower) than the power consumption of a prior art system that is built to perform the entire process of object detection, and determining which driving operation to perform). At least some of the power savings can be attributed to the fact the high-level sensed information unit context may not include location information, there is no need to determined whether objects of different sizes are the same type of objects, and the like.

A narrow AI agent may receive input directly from the sensors (for example—as an output of the perception module) and provides as an output a group driving related output, e.g. whether to perform angle of a steering wheel, acceleration/brake signal, or control of any other aspect of driving, etc.

The outputs from the different selected narrow AI agents are fed to a group driving related output determination unit 630 that outputs the group driving related output.

The group driving related output determination unit 630 may apply any example illustrate din relation to step 350 and/or may apply at least one other method—such as but not limited to arbitration, competition, selecting a response based on a risk imposed by adopting an output of a narrow AI agent, and the like.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarding the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method. \

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any reference to a machine learning process should be applied mutatis mutandis to a neural network. Any reference to a neural network should be applied mutatis mutandis to a machine learning process.

Any combination of any module or unit listed in any of the figures, any part of the specification and/or any claims may be provided. The vehicle may be any type of vehicle—such as a ground transportation vehicle, an airborne vehicle, or a water vessel.

The specification and/or drawings may refer to a sensed information unit. An image is an example of a sensed information unit. Any reference to an image may be applied mutatis mutandis to any type of natural signal such as but not limited to signal generated by nature, signal representing human behavior, signal representing operations related to the stock market, a medical signal, financial series, geodetic signals, geophysical, chemical, molecular, textual, and numerical signals, time series, and the like. Any reference to a media unit may be applied mutatis mutandis to sensed information. The sensed information may be of any kind and may be sensed by any type of sensors—such as a visual light camera, an audio sensor, a sensor that may sense infrared, radar imagery, ultrasound, electro-optics, radiography, LIDAR (light detection and ranging), etc. The sensing may include generating samples (for example, pixel, audio signals) that represent the signal that was transmitted, or otherwise reach the sensor.

The specification and/or drawings may refer to a processor. The processor may be a processing circuitry (also referred to as a processing circuit). The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

The sensed information unit may be sensed by one or more sensors of one or more types. The one or more sensors may belong to the same device or system—or may belong to different devices of systems.

We claim

1. A method of a pixel based with object based decision making for driving, the method comprises:
receiving, at a first machine learning process of an artificial intelligence agent, a sensed information unit;
receiving, at a second machine learning process of the artificial intelligence agent, object descriptive information regarding an object captured in the sensed information unit; the object descriptive information is less detailed than the sensed information unit;
generating, by the first machine learning process, a pixel-based path planning output related to a suggested pixel-based path segment of a vehicle;
generating, by the second machine learning process, an object-based path planning output related to a suggested object-based path segment of the vehicle; and
generating, by at least in part processing the pixel-based path planning output in correspondence with the object-based path planning output, a driving related output with respect to the vehicle, such that the driving related output conforms to at least one of the pixel-based path planning output and the object-based path planning output, wherein the first machine learning process and the second machine learning running concurrently for decision making driving of the vehicle.

2. The method according to claim 1, further comprising selecting the artificial intelligence agent out of a group of artificial intelligence agents.

3. The method according to claim 2, further comprising determining a scenario being faced by the vehicle, based on the sensed information unit; wherein the selecting of the artificial intelligence agent is based in the scenario.

4. The method according to claim 1, further comprising:
determining, by the first machine learning process, a suggested pixel-based path segment confidence level; and
determining, by the second machine learning process, a suggested object-based path segment confidence level; wherein the generating of the driving related output is responsive to the suggested pixel-based path segment confidence level and to the suggested object-based path segment confidence level.

5. The method according to claim 1, wherein the object descriptive information comprises object location information relating to the captured object in an environment of the vehicle, and kinematic information indicative a relative velocity between the captured object and the vehicle.

6. The method according to claim 1, wherein the generating of the driving related output is based in part on a safety parameter.

7. The method according to claim 1, wherein the generating of the driving related output is based in part on a comfort of a passenger of the vehicle.

8. The method according to claim 1, further comprising identifying that the pixel-based path planning output contradict the object-based path planning output and responding to the contradiction.

9. The method according to claim 1, further comprising:
selecting, concurrently with the selecting of the artificial intelligence agent, another artificial intelligence agent;
receiving, at another first machine learning process of the other artificial intelligence agent, the sensed information unit;
receiving, at another second machine learning process of the other artificial intelligence agent, the object descriptive information;
generating, by the other first machine learning process, another pixel-based path planning output related to another suggested pixel-based path segment of the vehicle;
generating, by the other second machine learning process, another object-based path planning output related to another suggested object-based path segment of the vehicle; and
generating, by at least in part processing the other pixel-based path planning output in correspondence with the other object-based path planning output, another driving related output with respect to the vehicle.

10. The method according to claim 9, further comprising generating, based on the driving related output and the other driving related output, a further driving related output.

11. A non-transitory computer readable medium for interactive neural network training for pixel based with object based decision making for driving, the non-transitory computer readable medium stores instructions executable by a processing circuit for:
receiving, at a first machine learning process of an artificial intelligence agent, a sensed information unit;
receiving, at a second machine learning process of the artificial intelligence agent, object descriptive information regarding an object captured in the sensed information unit; the object descriptive information is less detailed than the sensed information unit;
generating, by the first machine learning process, a pixel-based path planning output related to a suggested pixel-based path segment of a vehicle;
generating, by the second machine learning process, an object-based path planning output related to a suggested object-based path segment of the vehicle; and
generating, by at least in part processing the pixel-based path planning output in correspondence with the object-based path planning output, a driving related output with respect to the vehicle, such that the driving related output conforms to at least one of the pixel-based path planning output and the object-based path planning output, wherein the first machine learning process and the second machine learning running concurrently for decision making driving of the vehicle.

12. The non-transitory computer readable medium according to claim 11, further storing instructions executable by the processing circuit for selecting the artificial intelligence agent out of a group of artificial intelligence agents.

13. The non-transitory computer readable medium according to claim 12, further storing instructions executable by the processing circuit for selecting determining a scenario being faced by the vehicle, based on the sensed information unit; wherein the selecting of the artificial intelligence agent is based in the scenario.

14. The non-transitory computer readable medium according to claim 11, further storing instructions executable by the processing circuit for selecting:
determining, by the first machine learning process, a suggested pixel-based path segment confidence level; and
determining, by the second machine learning process, a suggested object-based path segment confidence level; wherein the generating of the driving related output is responsive to the suggested pixel-based path segment confidence level and to the suggested object-based path segment confidence level.

15. The non-transitory computer readable medium according to claim 11, wherein the object descriptive information comprises object location information relating to the captured object in an environment of the vehicle, and kinematic information indicative a relative velocity between the captured object and the vehicle.

16. The non-transitory computer readable medium according to claim 11, wherein the generating of the driving related output is based in part on a safety parameter.

17. The non-transitory computer readable medium according to claim 11, wherein the generating of the driving related output is based in part on a comfort of a passenger of the vehicle.

18. The non-transitory computer readable medium according to claim 11, further storing instructions executable by the processing circuit for selecting identifying that the pixel-based path planning output contradict the object-based path planning output and responding to the contradiction.

19. The non-transitory computer readable medium according to claim 11, further storing instructions executable by the processing circuit for selecting:
selecting, concurrently with the selecting of the artificial intelligence agent, another artificial intelligence agent;
receiving, at another first machine learning process of the other artificial intelligence agent, the sensed information unit;
receiving, at another second machine learning process of the other artificial intelligence agent, the object descriptive information;
generating, by the other first machine learning process, another pixel-based path planning output related to another suggested pixel-based path segment of the vehicle;
generating, by the other second machine learning process, another object-based path planning output related to another suggested object-based path segment of the vehicle; and
generating, by at least in part processing the other pixel-based path planning output in correspondence with the other object-based path planning output, another driving related output with respect to the vehicle.

20. The non-transitory computer readable medium according to claim 19, further storing instructions executable by the processing circuit for selecting generating, based on the driving related output and the other driving related output, a further driving related output.
